(19) United States
(12) Patent Application Publication
(10) Pub. No.: US 2023/0200373 A1
(43) Pub. Date: Jun. 29, 2023

(54) DEVICE FOR RODENT CONTROL

(71) Applicant: Patricia HOLMES, Half Moon Bay, CA (US)

(72) Inventor: Patricia HOLMES, Half Moon Bay, CA (US)

(21) Appl. No.: 17/563,043

(22) Filed: Dec. 28, 2021

(51) Int. Cl. A01M 29/16; G10K 3/00

(52) U.S. Cl. CPC A01M 29/16; G10K 3/00

(57) ABSTRACT

A device for vermin and rodent control is disclosed. The device generates a unique shudder and rhythm tone that mimics a predator, such as a rattlesnake. The device’s output (energy) is transferred to the entire environment around the device when it is positioned inside a vermin tunnel. The device includes a motor that causes the plurality of rigid spheres that are located freely in a container. The rigid spheres move in the container and movement produces a shudder and rhythm tone. A device’s unique randomization system prevents vermin such as gophers and moles from habituating to the shudder and rhythm tone generated by the device.

### FIELD OF THE INVENTION

This invention is in the field of mechanical devices and, more specifically, related to a device that uses a vibration motor along with rigid spheres for rodent control.

### BACKGROUND

Vermin, such as moles, gophers, ground squirrels or rodents, make a tunnel through the ground for purposed of eating insects and vegetation, thus resulting in damage to landscaping, lawns, shrubs, and aesthetic garden designs along with any structures above it. There are some devices and techniques that have been developed for eradicating various vermin, however, existing devices (or methods) are not effective. For example, known methods including using a spiked sounding device that generates sounds above the ground level that is intended to repelling rodents. Additionally, other known methods include applying vibration on the surface of the ground or in the vicinity of hole in the ground. The vibration transmitted to the ground has a little to no effect and the rodents or moles adapt to or ignore the vibration despite the vibration changing periodically. Therefore, what is needed is a device that effectively repels vermin and successfully keeps them from returning.

### SUMMARY

In accordance with various embodiments and aspects of the invention, a device or control system/device (and method) is disclosed that effectively repels rodents, gophers, or moles. The problems mentioned above are solved by the repel device and method that generates a unique shudder and rhythm tone, which replicates the behavior of hunters of or predators to rodents, gophers, and moles. For example, a rattlesnake is such a hunter or predator. The repel device generates and transfers the shudder and rhythm tone to the entire environment as the device is positioned inside a vermin tunnel. The shudder and rhythm tone are sensed or detected by the gopher, moles, and rodents; this causes them to fear the presence of a predator and, hence, run away or be repelled.

In accordance with various embodiments and aspects of the invention, as detailed below, a motor is used that generates or produces oscillation, movement, and/or vibration energy. This motor is enclosed in a container with a plurality of rigid spheres. The motor causes the plurality of rigid spheres, that are located freely in the container, to move in the container. The combination of the movement of the plurality of rigid spheres, contact of the rigid spheres with the motor, and the motor’s contact with the container’s wall, collectively, produce a resulting shudder and rhythm tone.

In accordance with one embodiment of the invention, as detailed below, a unique randomization system prevents vermin, such as gopher or moles, from adapting to the shudder and rhythm tone generated by the device. This randomized system may be done by inserting a copper sleeve into the pipe surrounding the motor. The rigid spheres’ contact with the copper sleeve’s wall collectively produces the energy resulting in a random (different from and inconsistent with respect to other tones produced without the copper sleeve) shudder and rhythm tone. Therefore, the (unfamiliar) shudder and rhythm tone prevents adaptation by the vermin resulting in vermin being repelled.

In accordance with one embodiment of the invention, as detailed below, the randomized system is done through the routine function of the solar panel in generating electric power by sunlight. In this way, because the solar panel’s energy production is unpredictable due to weather changes, the vermin cannot adapt to (and associated it with or ignore it as a non-predatory sound) the shudder and rhythm tone patterns. Therefore, the unfamiliar shudder and rhythm tone causes vermin to repel.

In accordance with one embodiment of the invention, as detailed below, the randomized system is done through the routine function of the solar panel and the battery in generating electric power. The controller switches between the power sources. If the solar panel’s voltage drops too low, it switches to the battery, and when the battery voltage goes low, it switches to the solar panel. This switching between the power sources creates an unfamiliar and random shudder and rhythm tone. Here, uncertain soils also produce noise that helps moles not adapt and habituated to the shudder and rhythm tone.

### BRIEF DESCRIPTION OF THE DRAWINGS

In order to more fully understand the invention, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1 shows a container of a device assembly including a cap, a lid, and a pipe in accordance with one or more embodiments and aspects of the invention.

FIG. 2 shows a solar panel as an example power source using in the device assembly, including a blocking diode, in accordance with one or more embodiments and aspects of the invention.

FIG. 3 shows an example implementation of a device assembly including a container, a motor, and the power source in accordance with one or more embodiments and aspects of the invention.

FIGS. 4A-4C show an example implementation of the use of the different power sources for the device assembly of FIG. 3 in accordance with one or more embodiments and aspects of the invention.

FIG. 5 shows an overview of the example implementation of the device assembly of FIG. 3 in accordance with one or more embodiments and aspects of the invention.

FIG. 6A shows an example of the impact of a device assembly including a container, a motor combined with ridged spears, and the power source inserted into a vermin tunnel in accordance with one or more embodiments and aspects of the invention.

FIG. 6B shows a device assembly without a motor inserted into a vermin tunnel in accordance with one or more embodiments and aspects of the invention.

FIG. 7 shows a cylindrical copper sleeve apparatus for use with the device assembly of FIG. 3 in accordance with one or more embodiments and aspects of the invention.

FIG. 8 shows an example implementation of a cylindrical copper sleeve apparatus for use with the device assembly of FIG. 3 in accordance with one or more embodiments and aspects of the invention.

### DETAILED DESCRIPTION

In the following description, numerous specific details are set forth to provide a thorough understanding of various embodiments. However, one skilled in the relevant art will recognize that the embodiments described herein can be practiced without one or more specific details or with other methods, components, materials, etc. In other instances, well-known structures, materials, or operations are not shown or described in detail to avoid obscuring certain aspects.

The following describes various embodiments of the present technology that illustrate various interesting aspects. Generally, embodiments can use the described aspects in any combination. All statements herein reciting principles, aspects, and embodiments are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one,” “an,” “certain,” “various,” “embodiments” or similar language means that a particular aspect, feature, structure, or characteristic described in connection with the embodiment is included in at least one embodiment. Thus, appearances of the phrase “in accordance with one embodiment of the invention”, and similar language throughout this specification may, but do not necessarily, all refer to the same embodiment or similar embodiments. Furthermore, aspects and embodiments described herein are merely by way of example, and should not be construed as limiting of the scope or spirit of the invention as appreciated by those of ordinary skill in the art. The invention is effectively made or used in any embodiment that includes any novel aspect described herein. Furthermore, to the extent that the terms “including”, “includes”, “having”, “has”, “with”, or variants thereof are used in either the detailed description and the claims, such terms are intended to be inclusive in a similar manner to the term “comprising.” In embodiments showing multiple similar elements, such as power source, even if using separate reference numerals, some such embodiments may work with a single element filling the role of the multiple similar elements.

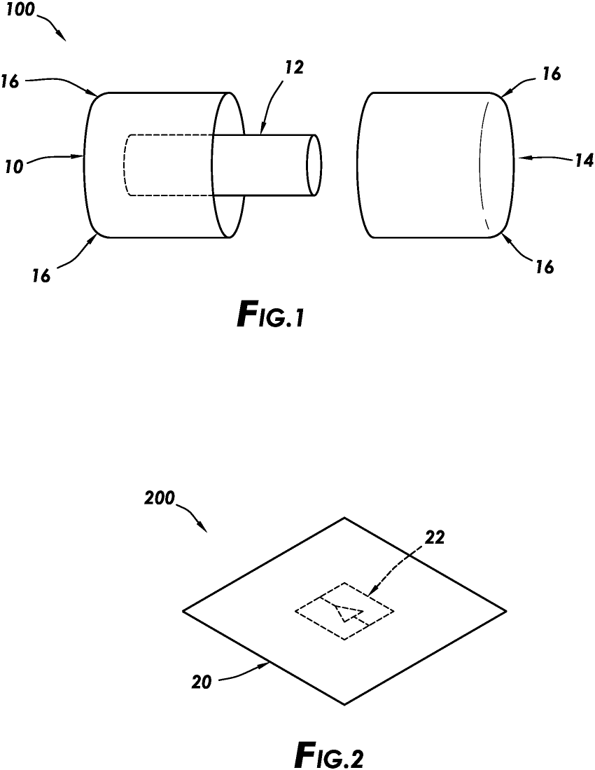

Referring now to FIG. 1, an exploded view of a housing or container 100 is shown in accordance with one or more embodiments and aspects of the invention. The container 100 includes a pipe 12, a cap 10, and a lid 14 that are PVC. In accordance with one or more embodiments and aspects of the invention, one or more of the pipe 12, the cap 10, and the lid 14 is copper. The pipe 12 is secured inside the cap 10 and secured with the lid 14, thereby creating a control environment within the container 100. The container 100 may be positioned inside a vermin tunnel, which is typically horizontal, to repel vermin. The cap 10 and the pipe 12 are typically have beveled or round edges 16 to avoid resistance when positioning the container 100 into the tunnel.

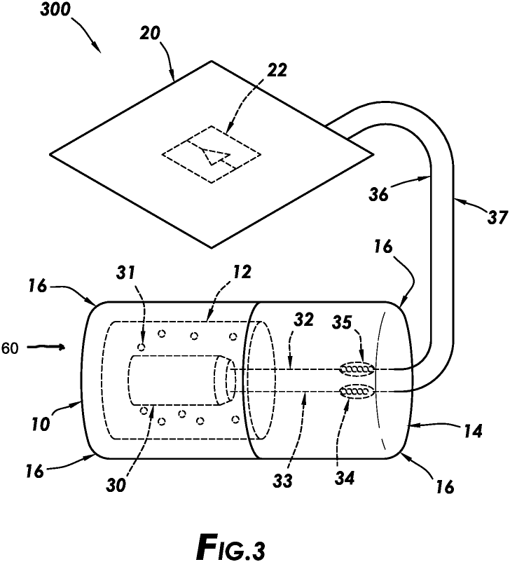

Referring now to FIG. 2, the solar panel 20 includes the blocking diode 22 to protect the solar panel 20 from over-charging and current backflow in accordance with some embodiments of the invention. According to various embodiments of the invention, the solar panel 20 has overall dimensions ranging from 3.15 in × 3.15 in to 4.57 in × 4.57 in with the specification of approximately 0.5 w 5 v 100 ma. While specific measurements are provided, the scope of the invention is not limited thereby, as any measurement range is acceptable to achieve the objective of the invention.

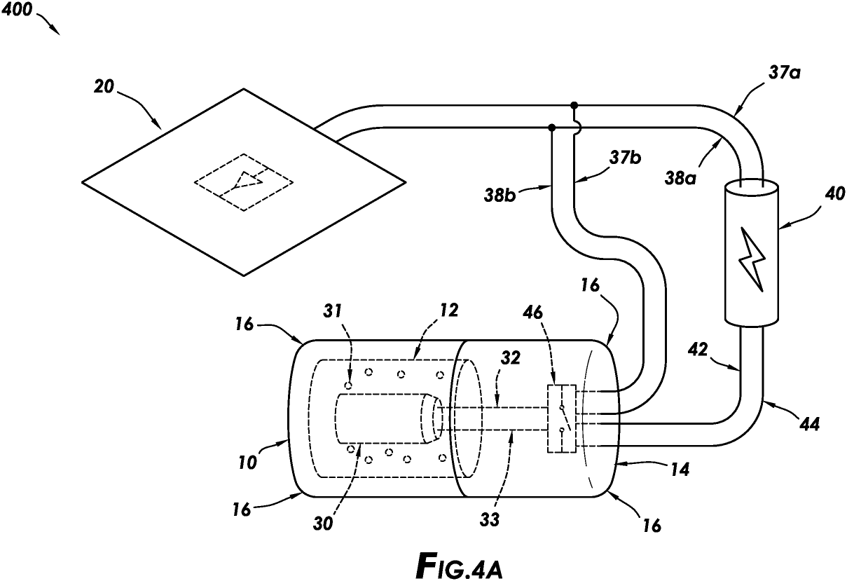

Referring now to FIG. 3, a device 300 that includes a motor 30 is shown in accordance with one or more embodiments and aspects of the invention. The motor 30 produces vibration, oscillation, and/or movement resulting in the produced energy. The motor 30, in accordance with one embodiment, is a DC (cylinder shaped) oscillating motor. In accordance with various aspects and embodiments of the invention, the terms oscillation and vibration are used interchangeably in reference to the behavior of the motor. In accordance with various aspects and embodiments of the invention, the lid 14 defines an opening, through which the power source’s first wire connector 36 and the power source’s second wire connector 37 are passed into the container 60. The device 300 includes a power source 20, which is positioned on top of a ground. Then power source’s first wire connector 36 and the power source’s second wire connector 37 are attached and soldered to the motor’s 30 first wire connector 32 and to the motor’s 30 second wire connector 33, respectively, positioned inside a container 60. The container 60 includes rounded corner 16 in accordance with one or more embodiments and aspects of the invention. In accordance with the various embodiments of the invention, the container 60 is made of copper type material. In accordance with the various embodiments of the invention, the container 60 is made of PVC type material. The solder joints 34 are electrically insulated from one another using insulation 35.

In accordance with one embodiment of the invention, the lid 14 defines an opening, through which the power source’s first wire connector 36 and the power source’s second wire connector 37 are passed into the container 60. The opening is sealed to prevent external environment elements, such as water and dirt, from entering the container 60. In addition, sealing the opening prevents the rigid spheres from exiting the container 60. In accordance with one embodiment of the invention, sealing the opening can be done using an epoxy capable of adhering to the PVC such as EP-200 Epoxy Putty.

In accordance with one embodiment of the invention, a motor 30 is located inside the pipe 12, which is inside the container 60. Rigid spheres 31 move freely within the container 60. The motor 30 inside the container 60 causes these rigid spheres 31 to move in the container 60. The movement of these rigid spheres 31 and the motor’s 30 contact with the container’s 60 wall (PVC or copper material) collectively produce the energy 57 that generates or results in the shuddering 58 and rhythm tone 56. The shuddering 58 and rhythm tone 56 combined with rigid spears, creates the effect like a predator or hunter, such as a rattlesnake, making the vermin, such as gopher and moles, run away or escape; this results in repelling the vermin.

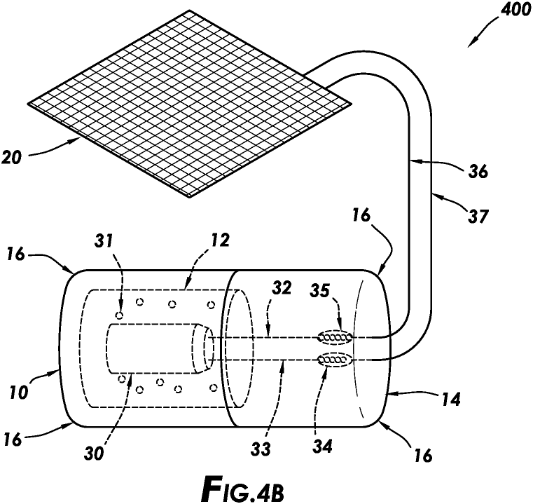

Referring now to FIG. 4A, in accordance with one embodiment of the invention, a device 400 includes a power source that is a combination of a battery 40 and the solar panel 20. The device 400 includes the solar panel 20 coupled with the battery 40, which are positioned on top of the ground. The solar panel 20 and the battery 40 are coupled with each other in parallel. A solar panel’s first wire connector 37a and a solar panel’s second wire connector 38a are attached to the battery 40 to allow the solar panel 20 to charge the battery 40.

The battery’s first wire connector 42 and the battery’s second wire connector 44 are coupled to the motor’s first wire connector 32 and the motor’s second wire connector 33, respectively, through a controller 46. A solar panel’s third wire connection 37b and a solar panel’s forth wire connection 38b coupled to the controller 46 to the motor’s first wire connector 32 and the motor’s second wire connector 33, respectively, through the controller 46. In accordance with various aspects and embodiments of the invention, the lid 14 defines an opening, through which the battery’s first wire connector 42, the battery’s second wire connector, the solar panel’s third wire connector 37b, and the solar panel’s fourth wire connector are passed into the container. The opening is then sealed as disclosed herein.

The controller 46 switches between the power sources as needed. For example, the controller 46 may be accessed remotely, using near-filed communication, such as Bluetooth or low-energy Bluetooth, in order to manually control switching. In accordance with another embodiments, a timer is used by the controller 46 to switch between power sources. In accordance with another embodiment, the controller 46 switches between power sources based on the power source’s output levels. If the solar panel’s voltage drops too low, it switches to the battery 40, and when the battery’s voltage is low, the controller 46 switches to the solar panel 20.

Referring now to FIG. 4B, in accordance with one embodiment of the invention, the power source is the solar panel 20 that includes the blocking diode 22. The device 400 includes the solar panel 20, which is positioned on top of the ground in accordance with various embodiments of the invention. The solar panel’s first wire connector 36 and the solar panel’s second wire connector 37 are attached and soldered to the oscillating motor’s first wire connector 32 and the oscillating motor’s second wire connector 33, respectively. The solder joints 34 are electrically insulated from one another using insulation 35. In accordance with various aspects and embodiments of the invention, the lid 14 defines an opening, through which the solar panel’s first wire connector 36 and the solar panel’s second wire connector 37 are passed into the container. The opening is then sealed as disclosed herein.

Referring now to FIG. 4C, in accordance with one embodiment of the invention, the power source can be the battery 40. The device 400 is coupled to the battery 40 in accordance with various embodiments of the invention. The battery’s first wire connector 42 and the battery’s second wire connector 44 are soldered to the motor’s first wire connector 32 and the motor’s second wire connector 33, respectively, and positioned inside the container to protect it from the environment. The solder joints 34 are electrically insulated from one another using insulation 35. In accordance with various aspects and embodiments of the invention, the lid 14 defines an opening, through which the battery’s first wire connector 42 and the battery’s second wire connector 44 are passed into the container. The opening is then sealed as disclosed herein.

In accordance with one embodiment of the invention, the motor 30 is cylinder shaped with the following specifications to properly fit in the container. It will be apparent to one skilled in the art that the shape of the oscillating motor, which is a DC motor, can be any shape. In accordance with one embodiment of the invention, a oscillating motor includes a dimensions approximately 0.27 in x 0.98 in with the IP67 (Ingress Protection), and the Voltage of approximately 1.5-3 v with the speed of approximately 8000-16000 RPM and power level of 0.01-0.06 W and the torque of approximately 0.3 g.cm-3 g.v cm (NM). In accordance with one embodiment of the invention, a motor 30 is a waterproof coreless oscillating motor. In accordance with one embodiment of the invention, the motor 30 can be remotely controlled using near field communication. For example, a communication link may be established using a wired connection, wireless protocols, near-field protocols, near field communication or RFID. In accordance with various embodiments of the invention, the motor 30 can be programmed to turn on and turn off, randomly, to preserve power and randomize the shudder and rhythm.

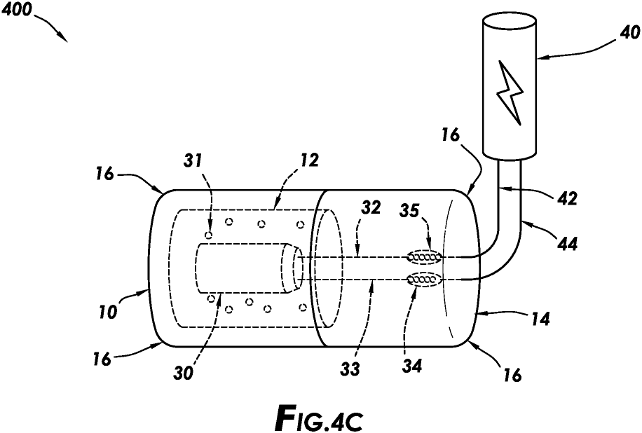

Referring now to FIG. 5, a diode 22 is shown under the solar panel 20. The diode 22 is attached underneath the solar panel 20. For clarity, the solar cells are not shown in this embodiment representation.

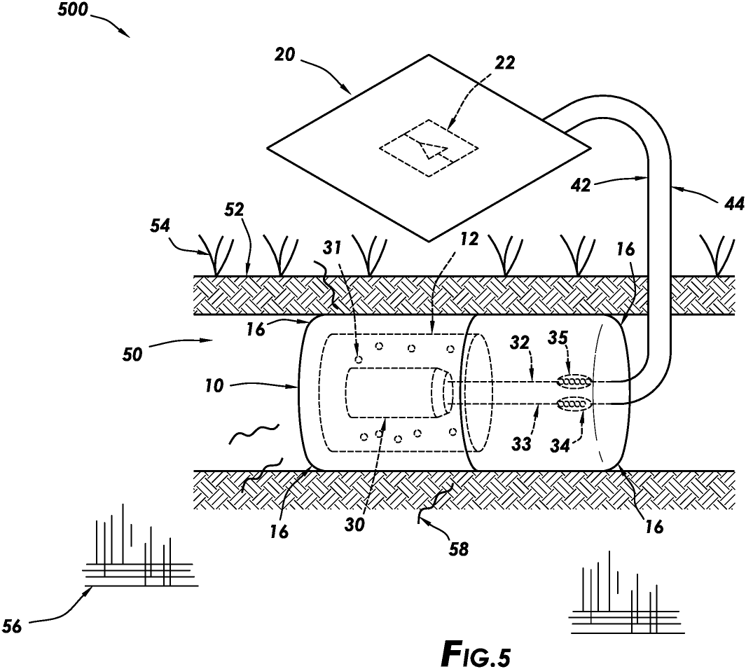

Referring now to FIGS. 6A and 6B, a device 600 includes a solar panel 20 with solar cells that are part of the solar panel 20, in accordance with various embodiments of the invention. Accordingly, as it is apparent from the FIG. 6A, when the solar panel 20 is generating power the motor 30 is active. The motor’s contact with the rigid spheres 31 and the container’s wall collectively produce the energy 57, shudder 58, and rhythm tones 56. In accordance with various embodiments of the invention, the container is made from PVC or copper, each of which material will create/generate the unique shudder and rhythm tone, when the rigid spheres 31 (and motor) contact the container’s wall. The shudder 58 and rhythm tone 56 transmit through the ground 52 and a grass 54 surrounding the vermin tunnel and repels them. Whereas, when there is no motor and/or rigid spears inside the container 60 (FIG. 6B) the device will not generate none of those impacts.

In accordance with one embodiment of the invention, a randomization system is a necessary operation to prevent vermin, such as gophers and moles, from adapting (habituate or adjust) to the shudder 58 and rhythm tone 56 generated by the device.

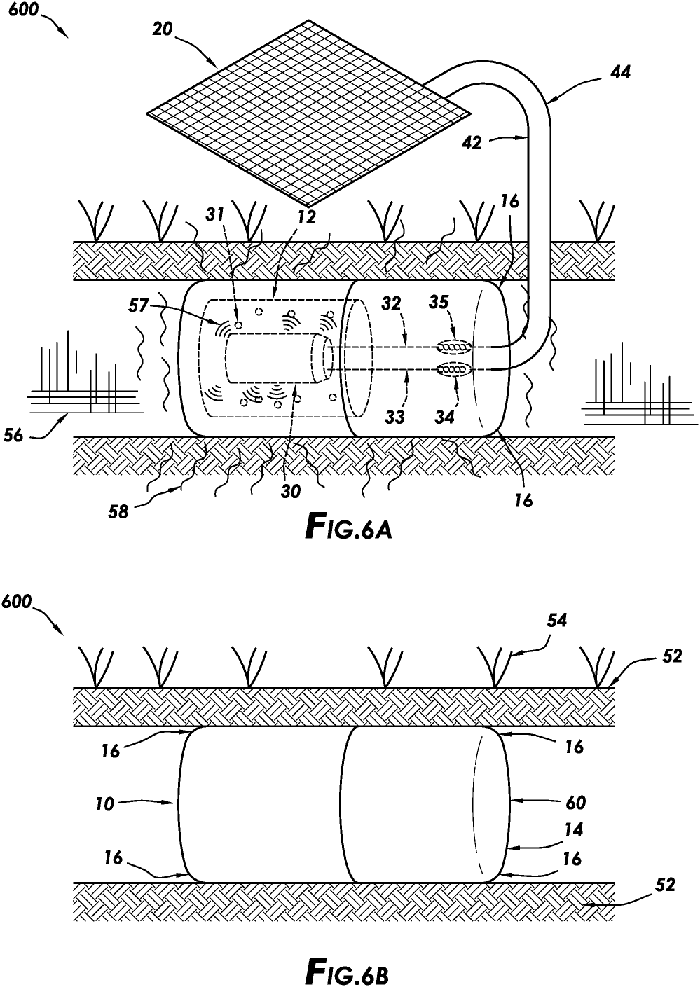

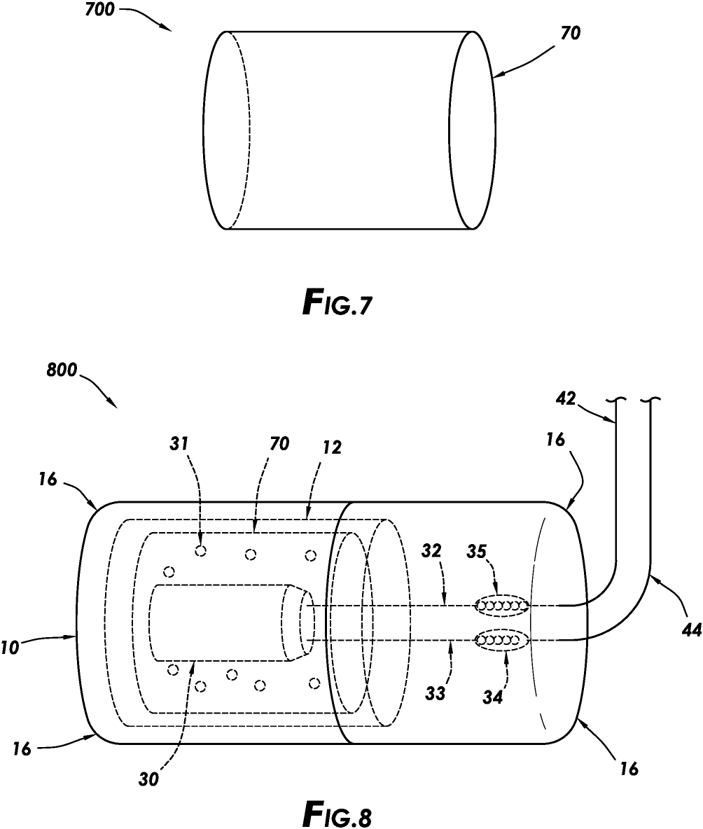

Referring now to FIG. 7 and FIG. 8, in accordance with one embodiment of the invention, a randomized system 700 uses a copper sleeve 70. Accordingly, the copper sleeve 70 fits into the pipe 12 around the motor 30 by inserting the copper sleeve 70 into the pipe 12, such that the ends of the copper sleeve 70 are within a space of the pipe and surrounding the motor 30. In this way, the rigid spheres 31 contact with the copper sleeve’s 70 wall collective produces the energy 57 resulting in an inconsistent shudder and rhythm tone from the previous one. Therefore, the unfamiliar shudder and rhythm tone causes vermin to repel.

In accordance with one embodiment of the invention, the randomized system may be done through the routine function of the solar panel 20 in generating electric power by sunlight. In this way, the solar panel 20 output is unpredictable based on changing weather and, thus, the vermin cannot recognize the shudder 58 and rhythm tone 56 patterns. Therefore, the unfamiliar shudder and rhythm tone causes vermin to be repelled.

In accordance with one embodiment of the invention, the randomized system is done through the routine function of the solar panel 20 and the battery 40 in generating electric power. The controller 46 switches between the power sources. If the solar panel’s voltage drops too low, it switches to the battery 40, and when the battery’s voltage goes low, it switches to the solar panel 20. This switching between the power sources creates an unfamiliar shudder and rhythm tone. Here, uncertain soils also produce noise that helps moles not habituated to the shudder 58 and rhythm tone 56.

In accordance with one embodiment of the invention, the method of using the invention may be that the container 60 goes horizontally into the vermin tunnel, and the power source stays on the ground’s 52 surface, as shown in FIG. 5. The power source generates electric power, which causes the motor 30 inside the container to oscillate. This oscillation, and energy 57, result in the rigid spheres 31 moving in the container 60. In accordance with one aspect and embodiment of the invention, the movement of these rigid spheres 31 and the motor’s contact with the container’s 60 wall (PVC or copper material) collectively produce energy 57 and the unique shudder 58 and rhythm tone 56. This shudder 58 and rhythm tone 56 transmit to the ground 52 around the vermin’s tunnel and repels the vermin.

In addition to the various embodiments described herein, it is to be understood that other similar embodiments can be used or modifications. Furthermore, additions can be made to the described implementation(s) for performing the same or equivalent function of the corresponding implementation(s) without deviating therefrom.

Practitioners skilled in the art will recognize many possible modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link. For example, a communication link may be established using a wired connection, wireless protocols, near-field protocols, near field communication or RFID.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Accordingly, the scope of the invention, therefore, is not intended to be limited to the embodiments shown and described herein. Rather, the scope and spirit of present invention is embodied by the appended claims.

What is claimed is:

1. A device comprising:
a power source including a first wire connector and a second wire connector;
a container including:
a pipe;
a cap; and
a lid, wherein the pipe includes a first end and a second end and the cap is secured to the first end of the pipe and the lid is secured to the second end of the pipe thereby sealing the container and preventing environmental elements from entering the container;
a motor positioned in the container, wherein the motor includes a first wire and a second wire connected to the first wire connector and the second wire connector, respectively, and the connection is positioned inside the container; and
a plurality of rigid spheres located freely in the container, such that the motor causes the plurality of rigid spheres to move in the container and contact of the plurality of rigid spheres and the motor with the container’s wall collectively produce a unique shudder and rhythm tone.

2. The device of claim 1, wherein the power source is a solar panel.

3. The device of claim 2 further comprising a diode installed on the solar panel’s back surface.

4. The device of claim 3, wherein the diode is a blocking diode to prevent the vibration motor from discharging backwards through the solar panel when the solar panel is not generating power to drive the motor.

5. The device of claim 1, wherein the motor is a DC cylinder shape oscillating motor.

6. The device of claim 1, wherein the first wire of the motor is solder connected to the first wire connector and the second wire of the motor is solder connected to the second wire connector, such that the solder connections are located inside the container.

7. The device of claim 1, wherein the solder connections are electrically insulating from one another.

8. The device of claim 1, wherein the pipe, the cap, and the lid are made of PVC.

9. The device of claim 1, wherein at least one of the pipe, the cap, and the lid is made of copper.

10. The device of claim 1, wherein the lid defines an opening, through which the power source’s first wire connector and the power source’s second wire connector is passed into the container.

11. The device of claim 10, wherein the opening is sealed to prevent external environment elements from entering the container.

12. The device of claim 1, wherein the power source is a combination of solar and battery.

13. A device comprising:
a power source;
a container including:
a pipe;
a cap; and
a lid, wherein the pipe includes a first end and a second end and the cap is secured to the first end of the pipe and the lid is secured to the second end of the pipe thereby sealing the container and preventing environmental elements from entering the container;
a motor positioned in the container and coupled to the powered source; and
a plurality of rigid spheres in the container,
wherein the motor causes the plurality of rigid spheres to move in the container and movement of the plurality of rigid spheres and the motor collectively produce a shudder and rhythm tone.
